(19) United States
(12) Patent Application Publication
(10) Pub. No.: US 2022/0219437 A1
(43) Pub. Date: Jul. 14, 2022

(54) METHOD FOR PRODUCING A MULTI-LAYER COMPOSITE FILM, MULTI-LAYER COMPOSITE FILM AND USE THEREOF

(71) Applicant: KUHNE ANLAGENBAU GMBH, St. Augustin/Menden (DE)

(72) Inventor: Jürgen Michael SCHIFFMANN, Hennef (DE)

(73) Assignee: KUHNE ANLAGENBAU GMBH, St. Augustin/Menden (DE)

(21) Appl. No.: 17/607,779

(22) PCT Filed: Apr. 30, 2020
(86) PCT No.: PCT/EP2020/062162

§ 371 Date: Oct. 29, 2021

(30) Foreign Application Priority Data
May 3, 2019 (DE) 10 2019 111 458.6

(51) Int. Cl. B32B 27/08; B32B 1/00; B32B 27/34; B32B 7/12; B32B 27/30; B32B 27/32; B32B 7/027; B32B 27/36; B65D 65/40; B29C 48/08; B29C 48/21

(52) U.S. Cl. CPC B32B 27/08; B29K 2027/08; B32B 27/34; B32B 7/12; B32B 27/306; B32B 27/32; B32B 27/304; B32B 27/308; B32B 7/027; B32B 27/36; B65D 65/40; B29C 48/08; B29C 48/21; B32B 2307/732; B32B 2307/31; B32B 2307/736; B32B 2307/414; B32B 2307/54; B32B 2439/70; B32B 2439/46; B32B 2307/7244; B32B 2307/7246; B32B 2250/24; B32B 2250/05; B32B 2270/00; B32B 2307/518; B32B 2307/72; B32B 1/00

(57) ABSTRACT

The present patent application relates to a method of manufacturing a multilayered composite film comprising a step of co-extruding at least three layers (a), (b) and (c), of which the layer (a) forms an outward surface of the composite film; the layer (c) forms a surface of the composite film facing or coming in contact with a good to be packaged; and the layer (b) is disposed between the layer (a) and the layer (c). Further, the method includes a step of biaxial orientation of the composite film thus co-extruded. Therein, the layer (a) contains or consists of a thermoplastic resin. The layer (b) contains or consists of a polyvinylidene chloride (PVdC) resin. The layer (c) contains or consists of a resin, preferably sealable, in particular heat-sealable resin. Therein, any crosslinking of the composite film by means of radioactive radiation, in particular by means of beta, gamma, X-ray and/or electron irradiation, is omitted during the manufacturing of the composite film and/or thereafter.

The invention relates to a method of manufacturing a multilayered composite film according to claim 1, a multilayered composite film according to claim 10 or 11, and the use of the composite film according to claim 20.

### STATE OF THE ART

Known are multilayered composite films which provide a polyamide resin as the main resin and EVOH as the gas barrier layer, wherein the properties required for the intended use, for example as a heat-shrinkable packaging film for food products, are achieved exclusively by means of the raw material combinations used. Therein, the use of larger percentages of the raw materials polyamide, EVOH and PET leads to relatively stiff films. In addition, especially when PA and EVOH are used, the dimensional stability of the film may be impaired due to the tendency of these raw materials to post-crystallize. The usage of EVOH as a layer component also has the disadvantage that its barrier properties against oxygen permeation decrease over time due to the effect of permeating moisture from the outside and from the inside. Therefore, in order to maintain a sufficient oxygen barrier, the EVOH-containing layer must be protected by embedding it in layers with a good water vapor barrier function, for example in the form of a sandwich arrangement, which disadvantageously increases the number of layers required and the complexity of the overall composite. In addition, composite films that use polyamide in one or more layers have the disadvantage of undesirable cold or post shrinkage. The use of polyamide in the outermost layer can further lead to an undesirable curling tendency, the so-called curling.

For example, DE 10 2006 046 483 A1 discloses a multilayer food casing or film for food packaging in which a central EVOH-based gas barrier layer is embedded by two polyolefin layers as a water-vapor barrier and which comprises a PET layer for heat resistance, puncture resistance and shrinkage.

For example, the disclosure EP 1 857 271 B1 discloses a 7-layer film and the disclosure DE 10 2006 036 844 B3 discloses a food casing or film for food packaging in which the EVOH layer is embedded between two PA layers, which in turn are embedded between two PO layers, and in which the outermost layer consists of PET.

On the other hand, multilayered composite films are known which are crosslinked by radiation and use PVdC as a barrier material. By means of radiation crosslinking by radioactive irradiation or irradiation with electrons, which is integrated in or downstream of the film production method, essential properties such as sufficiently high shrinkage, good puncture resistance and heat resistance, which advantageously supplement the oxygen, gas and aroma barrier properties originally already present in PVdC, are achieved. As shown in the following Table 1, the use of radiation crosslinked PVdC completely eliminates cold shrinkage compared to other conventional films.

TABLE 1
Cold shrinkage measured after 24 hours in water at a temperature of 20°
C. for conventional multilayer films based on EVOH vs. radiation crosslinked
PVdC (MD = machine direction; TD = transverse direction) (ASTM 2732)

| | | | PVdC 1 | PVdC 2 | PVdC 3 |
|---|---|---|---|---|---|
| | | | (radiation | (radiation | (radiation |
| 7-layer PA | 9-layer | 7-layer PO | crosslinked) | crosslinked) | crosslinked) |
| PA/HV/PA/ | PET/HV/IO/ | PET/HV/IO/HV/ | EVA/HV(EVA)/ | EVA/HV(EVA)/ | EVA/HV(EVA)/ |
| EVOH/PA/ | HV/PA/EVOH/ | EVOH/HV/PE | PVdC/HV(EVA)/ | PVdC/HV(EVA)/ | PVdC/HV(EVA)/ |
| HV/PE | PA/HV/PE | | EVA | EVA | EVA |
| MD: 4-7% | 3-5% | 1-3% | 0% | 0% | 0% |
| TD: 4-5% | 3-4% | 0.5-1% | 0% | 0% | 0% |

However, radiation crosslinked composite films often have the disadvantage that, due to the interaction of the raw materials and the radiation crosslinking, the appearance in terms of haze, gloss and coloring (brown or yellowish) is not satisfactory. For example, the haze of films based on radiation crosslinked PVdC is significantly increased compared to other conventional films, as shown in the following table 2.

TABLE 2
Haze measured for conventional multilayer films based
on EVOH vs. radiation crosslinked PVdC (ASTM D1003).

| | | | PVdC 1 | PVdC 2 | PVdC 3 |
|---|---|---|---|---|---|
| | | | (radiation | (radiation | (radiation |
| 7-layer PA | 9-layer | 7-layer PO | crosslinked) | crosslinked) | crosslinked) |
| PA/HV/PA/ | PET/HV/IO/ | PET/HV/IO/HV/ | EVA/HV(EVA)/ | EVA/HV(EVA)/ | EVA/HV(EVA)/ |
| EVOH/PA/ | HV/PA/EVOH/ | EVOH/HV/PE | PVdC/HV(EVA)/ | PVdC/HV(EVA)/ | PVdC/HV(EVA)/ |
| HV/PE | PA/HV/PE | | EVA | EVA | EVA |
| 5.80% | 6.40% | 8.50% | 10.60% | 14.40% | 14.30% |

In addition, the processing of radiation crosslinked composite films is limited by the relatively low or limited number of cycles on processing machines due to the suboptimal heat resistance and the sometimes too low stiffness of the film, as shown in the following Table 3.

TABLE 3
Stiffness, measured as modulus of elasticity, of conventional multilayer
films based on EVOH vs. radiation crosslinked PVdC (data in MPa; MD =
machine direction; TD = transverse direction) (DIN EN ISO 527)

| | | | PVdC 1 | PVdC 2 | PVdC 3 |
|---|---|---|---|---|---|
| | | | (radiation | (radiation | (radiation |
| 7-layer PA | 9-layer | 7-layer PO | crosslinked) | crosslinked) | crosslinked) |
| PA/HV/PA/ | PET/HV/IO/ | PET/HV/IO/HV/ | EVA/HV(EVA)/ | EVA/HV(EVA)/ | EVA/HV(EVA)/ |
| EVOH/PA/ | HV/PA/EVOH/ | EVOH/HV/PE | PVdC/HV(EVA)/ | PVdC/HV(EVA)/ | PVdC/HV(EVA)/ |
| HV/PE | PA/HV/PE | | EVA | EVA | EVA |
| MD: 731.4 | 560.2 | 560.8 | ≈249 | ≈340 | ≈220 |
| TD: 687.2 | 483.8 | 513.8 | ≈251 | ≈270 | ≈215 |

The usage of a radiation crosslinked film with PVdC as a barrier layer also has the fundamental disadvantage that the oxygen barrier to be achieved is lower than with EVOH. In contrast, the oxygen barrier of films with PVdC remains stable over the long term, regardless of external influences and regardless of the influence of moisture, as shown in the following Table 4.

TABLE 4
Oxygen permeability at 20° C., measured for various barrier plastics
(according to Kyoichiro; from: Joachim Nentwig, Kunststoff-Folien,
3rd edition, 2006, Carl Hanser Verlag; Table 26).

| | Oxygen permeability at | |
|---|---|---|
| | 65% rel. humidity | 80% rel. humidity |
| Plastic | $[ \frac{{cm}^{3}}{{m}^{2} \cdot d \cdot bar} ]$ | $[ \frac{{cm}^{3}}{{m}^{2} \cdot d \cdot bar} ]$ |
| EVOH (PE 32 mole %) | 0.5 | 1.2 |
| EVOH (PE 44 mole %) | 1.0 | 2.3 |
| PVDC (extrusion resin) | 4 | 4 |
| PVDC (dispersion resin) | 10 | 10 |
| PAN | 8 | 10 |
| PET | 50 | 50 |
| PA6 | 35 | 50 |
| PVC | 240 | 240 |
| PE-HD | 2 500 | 2 500 |
| PP | 3 000 | 3 000 |
| PE-LD | 10 000 | 10 000 |
| EVA | 18 000 | 18 000 |

However, incorrect or poorly dosed radiation crosslinking can lead to a detrimental reduction in the sealability of the film. Particularly with regard to EVA, the sealability of the film can be completely lost through radiation crosslinking. In addition, radiation crosslinked films cannot be recycled, but must be disposed of at great expense.

### OBJECT THE INVENTION

It is therefore an object of the present invention to provide a composite film and a method for its manufacturing which avoids, as far as possible, at least one of the above-discussed deficiencies of the composite films known from the state of the art. In particular, it is an object to provide a composite film which has at least one, preferably several, of the following properties: a high shrinkage, a high processability (high number of cycles), a high puncture resistance, a high heat resistance, good optical properties in the sense of low haze and/or low color cast, recyclability and, as far as possible, a long-term, uninfluenceable or stable oxygen barrier. The presence of a low haze of the composite film is particularly advantageous.

### DISCLOSURE OF THE INVENTION

The object is solved by the method according to claim 1.

Thereby, a method for manufacturing a multilayer composite film is proposed for the first time, wherein the method includes at least the following steps:

a step of co-extruding at least three layers (a), (b) and (c), of which
the layer (a) forms an outward surface of the composite film;
the layer (c) forms a surface of the composite film facing or coming in contact with a good to be packaged; and
the layer (b) is disposed between the layer (a) and the layer (c); and

a step of biaxial orientation of the composite film thus co-extruded;

wherein the layer (a) contains or consists of a thermoplastic resin;

wherein the layer (b) contains or consists of a polyvinylidene chloride (PVdC) resin;

wherein the layer (c) contains or consists of a resin, preferably a sealable resin, in particular a heat-sealable resin;

wherein the thermoplastic resin of the layer (a) has a density of 0.94 g/cm³ or more; and

wherein any crosslinking of the composite film by means of radioactive radiation, in particular by means of beta, gamma, X-ray and/or electron irradiation, is omitted during the manufacturing of the composite film and/or thereafter.

The use of non-radiation crosslinked composite films with PVdC has the advantage over certain other materials used as an oxygen barrier that the barrier property to water or water vapor, and in particular to oxygen, remains constant over a long period of 3 to 6 months or longer. Consequently, the stability of the barrier over time is improved compared to the use of an ethylene-vinyl alcohol copolymer (EVOH) in particular as a barrier material in an inner or intermediate layer, which is a considerable advantage especially in the case of a long shelf life of the packaged good, in particular a foodstuff

The thermoplastic resin of the layer (a) has a density of 0.94 g/cm³ or more, preferably 0.96 g/cm³ or more, preferably between 0.96 and 2 g/cm³, more preferably between 0.96 and 1.5 g/cm³. If a resin or polymer with a high density, in particular PET, a PA or a PO with a correspondingly high density, is used as a layer component for the layer (a), a high puncture resistance of the entire composite film and a high heat resistance of the layer (a) are advantageously achieved. In addition, a resin from the PA or PET material groups with a high density in the layer (a) gives the composite film appealing optical properties, such as transparency and gloss. Furthermore, such an outer layer (a) with a high density can also ensure improved further processing in terms of high number of cycles.

Advantageous embodiments are the subject-matter of the dependent claims.

In a preferred embodiment, the thermoplastic resin of the layer (a) of the composite film according to the invention can contain or consist of a polyester, preferably a polyethylene terephthalate (PET), or a polylactic acid or a polylactide (PLA), a polyamide (PA), a polyolefin (PO), an ethylene-vinyl acetate copolymer (EVA), an ethylene-methyl methacrylate copolymer (EMMA), an ethylene-methacrylic acid copolymer (EMA), an ionomer (IO), or any mixture thereof.

The provision of polyamide in the layer (a) ensures high heat resistance, high strength, in particular puncture resistance, and adequate shrinkage. These advantages are achieved in particular if the layer (a) contains or consists of PET instead of the polyamide. By providing PET instead of PA in the layer (a), the cold shrinkage or post-crystallization shrinkage that can occur when PA is used as a layer component due to post-crystallization is also effectively reduced or even avoided (see the following Table 9). Unlike PA, PET is brought to a crystallized state during biaxial orientation as part of the manufacturing method. In addition, the inclusion of PET in the layer (a) effectively avoids the curling tendency, which is common with partially crystallized PA. PA in the outermost layer is also characterized by excellent printability of the composite film. In addition, PLA offers significantly better barrier protection compared to polyolefin-based raw materials, such as PE or PP, especially after stretching, particularly after biaxial orientation.

Furthermore, in addition to the heat resistance of the outermost layer (a), the use of the raw materials optionally provided for the layer (a) according to the invention, such as polyester, preferably a polyethylene terephthalate (PET) or a polylactic acid (PLA), a polyamide (PA), or any mixture thereof, also results in an increased stiffness and thus also improved process stability during stretching, more precisely during biaxial orientation of the bubble-shaped film. And due to the sufficient stiffness of the composite film according to the invention, higher number of cycles and thus, an improved processability (bagging) can be achieved.

The improved stiffness of the film according to the invention can be seen in the following Table 5.

TABLE 5
Stiffness, measured as modulus of elasticity, of the multilayer film according to the
invention in comparison with conventional multilayer films based on EVOH and radiation
crosslinked PVdC (data in MPa; MD = machine direction; TD = transverse direction;
* = composite film according to the invention as per Table 10, Example 1) (DIN EN ISO 527)

| | | | PVdC 1 | PVdC 2 | PVdC 3 | Invention* |
|---|---|---|---|---|---|---|
| | | | (radiation | (radiation | (radiation | (not radiation |
| 7-layer PA | 9-layer | 7-layer PO | crosslinked) | crosslinked) | crosslinked) | crosslinked) |
| PA/HV/PA/ | PET/HV/IO/ | PET/HV/IO/ | EVA/HV(EVA)/ | EVA/HV(EVA)/ | EVA/HV(EVA)/ | PET/HV/PP/HV/ |
| EVOH/PA/ | HV/PA/EVOH/ | HV/EVOH/ | PVdC/HV(EVA)/ | PVdC/HV(EVA)/ | PVdC/HV(EVA)/ | PVdC/HV/PE |
| HV/PE | PA/HV/PE | HV/PE | EVA | EVA | EVA | |
| MD: 731.4 | 560.2 | 560.8 | ≈249 | ≈340 | ≈220 | 472.8 |
| TD: 687.2 | 483.8 | 513.8 | ≈251 | ≈270 | ≈215 | 438.6 |

Surprisingly, the use of the raw materials of the invention in the layer (a) results in significantly higher processability (numbers of cycles) than comparable radiation crosslinked composite films, as can be seen from the following Table 6, due to the heat resistance caused by the raw materials or the resulting high Vicat softening temperature and the associated high stiffness even at high temperatures, combined with the basically higher stiffness of the raw materials used compared to the raw materials used in radiation crosslinked films.

TABLE 6
Comparison of the number of cycles for EVOH-based and
PVDC-based films (bagging or manufacturing of bags)
(data in cycles per minute; * = composite film
according to the invention as shown in Table 10, Example 1)

| | | | | | | Invention* |
|---|---|---|---|---|---|---|
| 7-layer | | 7-layer | | | | (not radiation |
| PA | 9-layer | PO | PVdC 1 | PVdC 2 | PVdC 3 | crosslinked |
| 100-120 | 100-120 | 100-120 | 60-80 | 60-80 | 60-80 | 100-120 |

The Vicat softening temperature according to DIN EN ISO 306, in conjunction with the stiffness, plays a decisive role in the further processing of the films produced, since in the downstream processes, such as bagging, the films are often subjected to high temperatures in some cases, and at a lower Vicat softening temperature they become very soft and can therefore only be further processed at moderate numbers of cycles despite good heat resistance (with regard to adhesion). This is mainly due to the lack of film stiffness at elevated temperatures.

This occurs particularly with radiation crosslinked films, since the main raw material here (80 to 90% layer content) is EVA and this raw material has an extremely low Vicat softening temperature. The EVA grades used have a Vicat softening temperature that is usually between 45 and 70° C., but not higher than 85° C. Ideally, therefore, raw materials are used specifically in the layer (a) which have a Vicat softening temperature of at least above 100° C. (see Table 7 below).

TABLE 7
Vicat softening temperature (VST) of various raw material grades (in ° C.; DIN EN ISO 306)

| Raw | EVA | EVA | EVA | | | random | | | | | homo |
|---|---|---|---|---|---|---|---|---|---|---|---|
| material | 28% | 18% | 12% | LLDPE | mLLDPE | Co-PP | Co-PP | PA6.66 | PA6 | Co-PET | PET |
| VST | 40-50 | 60-70 | 70-85 | 100-120 | 100-120 | 100-120 | 120-140 | 180-200 | 190-210 | 210-230 | 240-260 |

Furthermore, the composite film according to the invention has a lower haze or a higher transparency and a higher gloss and thus improved optical properties compared to radiation crosslinked composite films, as can be seen in the following Table 8.

TABLE 8
Haze measured for the multilayer film according to the invention compared to conventional multilayer
films based on EVOH and radiation crosslinked PVdC; (MD = machine direction; TD = cross
direction; * = composite film according to the invention as shown in Table 10, Example 1) (ASTM D1003).

| | | | PVdC 1 | PVdC 2 | PVdC 3 | Invention* |
|---|---|---|---|---|---|---|
| | | | (radiation | (radiation | (radiation | (not radiation |
| 7-layer PA | 9-layer | 7-layer PO | crosslinked) | crosslinked) | crosslinked) | crosslinked |
| PA/HV/PA/ | PET/HV/IO/ | PET/HV/IO/ | EVA/HV(EVA)/ | EVA/HV(EVA)/ | EVA/HV(EVA)/ | PET/HV/PP/HV/ |
| EVOH/PA/ | HV/PA/EVOH/ | HV/EVOH/ | PVdC/HV(EVA)/ | PVdC/HV(EVA)/ | PVdC/HV(EVA)/ | PVdC/HV/PE |
| HV/PE | PA/HV/PE | HV/PE | EVA | EVA | EVA | |
| 5.80% | 6.40% | 8.50% | 10.60% | 14.40% | 14.30% | 6.70% |

The composite film according to the invention can comprise a sealing layer which, despite or precisely because of the temperature introduced from the outside, begins to seal earlier than the outermost layer in order to ensure that the film to be sealed seals internally before it bonds with the outermost layer at the sealing tool (sealing bar).

According to the invention, the risk of incorrect or poorly dosed radiation crosslinking is eliminated by completely dispensing with radiation crosslinking. This avoids the risk of radiation-induced deterioration in the sealability of the composite film.

In addition, the composite film remains recyclable due to the complete elimination of radiation crosslinking.

The thermoplastic resin of the layer (a) can be a material with a melting temperature or melting point of 170° C. or higher, preferably 175° C. or higher, preferably 180° C. or higher.

By selecting a resin with such a high melting temperature or melting point as a layer component of the layer (a), high numbers of cycles can be achieved during manufacturing due to the higher heat resistance or the significantly higher Vicat softening temperature (DIN EN ISO 306). Despite very high temperatures at the sealing bar, adhesion of the film to the sealing bar or of films or film parts to one another is avoided.

TABLE 9
Cold shrinkage, measured after 24 hours in water at a temperature of 20° C., of the multilayer
film according to the invention in comparison with conventional multilayer films based on EVOH
and radiation crosslinked PVdC (data in %; MD = machine direction; TD = transverse
direction; * = composite film according to the invention according to Table 10, Example 1) (ASTM 2732)

| | | | PVdC 1 | PVdC 2 | PVdC 3 | Invention* |
|---|---|---|---|---|---|---|
| | | | (radiation | (radiation | (radiation | (not radiation |
| 7-layer PA | 9-layer | 7-layer PO | crosslinked) | crosslinked) | crosslinked) | crosslinked |
| PA/HV/PA/ | PET/HV/IO/ | PET/HV/IO/ | EVA/HV(EVA)/ | EVA/HV(EVA)/ | EVA/HV(EVA)/ | PET/HV/PP/HV/ |
| EVOH/PA/ | HV/PA/EVOH/ | HV/EVOH/ | PVdC/HV(EVA)/ | PVdC/HV(EVA)/ | PVdC/HV(EVA)/ | PVdC/HV/PE |
| HV/PE | PA/HV/PE | HV/PE | EVA | EVA | EVA | |
| TD: 4-7% | 3-5% | 1-3% | 0% | 0% | 0% | 0.5-1% |
| MD: 4-5% | 3-4% | 0.5-1% | 0% | 0% | 0% | 0-0.5% |

Especially when the layer (a) contains or consists of polyamide or PET, and neither the composite film nor individual layers are crosslinked by radiation, it has been surprisingly shown that the composite film exhibits excellent transparency or low haze and excellent gloss.

In an advantageous embodiment, the thermoplastic resin of the layer (a) of the composite film according to the invention has a sealing temperature (measured at 1 bar, air atmosphere, 23° C.) which is equal to or higher than the sealing temperature of the resin of the layer (c) (measured at 1 bar, air atmosphere, 23° C.). The thermoplastic resin of the layer (a) can be, in particular, one of the polymer materials mentioned above for the layer (a) or a mixture of at least two of these polymer materials.

By selecting a thermoplastic resin for the layer (a) with a sealing temperature equal to or higher than the sealing temperature of the resin of the layer (c), adhesion of the film to the sealing bar or of films or film parts to one another can be advantageously avoided.

In a further preferred embodiment, the composite film can have a haze (ASTM D1003) of at most 15%, preferably at most 12%, preferably at most 10%, preferably at most 7%, in particular at most 5%. This realizes the desired optical properties of the composite film according to the invention. Accordingly, the optical appearance of the resulting composite film and the recognizability/inspectability of the good packaged therewith by the purchaser of the good are improved without having to open the packaging. In particular, the haze of the composite film discussed above can be combined with the feature discussed above of the same or higher sealing temperature of the thermoplastic resin of the layer (a) compared to the resin of the layer (c).

It is particularly advantageous if, according to the invention, the choice of a thermoplastic resin for the layer (a) with an equal or higher sealing temperature than the sealing temperature of the resin of the layer (c) is combined with the above-described low haze values of the multilayer film.

Additionally or alternatively, the composite film may have a stiffness (DIN EN ISO 527), expressed as modulus of elasticity or Young's modulus, measured in the machine direction, of at least 200 MPa, preferably at least 250 MPa, preferably at least 300 MPa, preferably at least 350 MPa, preferably at least 400 MPa, in particular at least 450 MPa. Additionally or alternatively, the composite film may have a stiffness (DIN EN ISO 527), expressed as modulus of elasticity, measured in the transverse direction, i.e., in a direction which is perpendicular or transverse to the machine direction, of at least 200 MPa, preferably at least 250 MPa, preferably at least 300 MPa, preferably at least 350 MPa, preferably at least 400 MPa, more particularly at least 450 MPa.

Additionally or alternatively, the composite film may have a stiffness (DIN EN ISO 527), expressed as modulus of elasticity, measured in the machine direction, of at most 700 MPa, preferably at most 650 MPa, preferably at most 600 MPa, preferably at most 550 MPa, in particular at most 500 MPa. In addition or alternatively, the composite film can have a stiffness (DIN EN ISO 527), expressed as modulus of elasticity, measured in the transverse direction, of at most 700 MPa, preferably at most 650 MPa, preferably at most 600 MPa, preferably at most 550 MPa, in particular at most 500 MPa.

According to the invention, the layer (a) or the composite film containing it according to the invention can be characterized in particular by one of the following features or any combination of the following features:
the thermoplastic resin of the layer (a) may contain or consist of a polyester, preferably PET or PLA, PA, PO, an ethylene-vinyl acetate copolymer (EVA), an ethylene-methyl methacrylate copolymer (EMMA), an ethylene-methacrylic acid copolymer (EMA), an ionomer (IO)), or any mixture thereof;
the thermoplastic resin of the layer (a) may have a sealing temperature (measured at 1 bar, air atmosphere, 23° C.) which is equal to or higher than the sealing temperature of the resin of the layer (c);
the thermoplastic resin of the layer (a) is a material having a melting temperature or melting point of 170° C. or higher, preferably 175° C. or higher, preferably 180 ° C. or higher, preferably between 170 and 300° C., preferably between 175 and 300° C., more preferably between 180 and 300° C.;
the haze of the composite film (ASTM D1003) may be limited to at most 15%, preferably at most 12%, preferably at most 10%, preferably at most 7%, in particular at most 5%;
the stiffness of the composite film (DIN EN ISO 527), expressed as modulus of elasticity, measured in the machine direction or transverse direction, may be limited to at least 200 MPa, preferably at least 250 MPa, preferably at least 300 MPa, preferably at least 350 MPa, preferably at least 400 MPa, in particular at least 450 MPa; and/or
the stiffness of the composite film (DIN EN ISO 527), expressed as modulus of elasticity, measured in the machine direction or transverse direction, may be limited to at most 700 MPa, preferably at most 650 MPa, preferably at most 600 MPa, preferably at most 550 MPa, in particular at most 500 MPa.

Within the scope of the present invention, a combination of at least two of the features disclosed above with reference to the features of the layer (a) is also possible, whereby further advantageous properties can be achieved.

In a preferred embodiment, the resin of the layer (c) may comprise or consist of a polyolefin (PO), preferably a polyethylene (PE) and/or a polypropylene (PP), an ethylene-vinyl acetate copolymer (EVA), an ionomer (TO), an ethylene-methyl methacrylate copolymer (EMMA), an ethylene-methacrylic acid copolymer (EMA), or any mixture thereof.

By providing a polyolefin (PO), preferably a polyethylene (PE) and/or a polypropylene (PP), or EVA, an ionomer (TO), an ethylene-methyl methacrylate copolymer (EMMA), an ethylene-methacrylic acid copolymer (EMA), or any mixture thereof, for example a mixture of PO and EVA, as the resin of the layer (c), excellent sealability is ensured. Particularly in the case of the layer component EVA, the absence of radiation crosslinking leads to a preservation of the excellent sealability, which would otherwise be lost or at least restricted by radiation crosslinking.

Furthermore, it is advantageous in terms of high shrinkage and not too high stiffness to provide a polyolefin as a component of the layer (c). Preferably, the layer (c) contains a high proportion of a polyolefin or consists of a polyolefin.

Moreover, the layer (a) may have a thickness in the range of 0.5 to 20 preferably 1 to 10 μm; and/or the thickness of the layer (a) may be at most 30%, preferably at most 10%, in particular at most 5%, of the thickness of the entire composite film.

By limiting the thickness of the layer (a) to a value in the range of 0.5 to 20 preferably 1 to 10 μm, it is ensured that only a small amount of the resin or resin mixture forming the layer (a) is incorporated into or applied to the composite film. By limiting the amount of material of the layer (a) in this way, trade-offs in terms of smoothness and associated damage to other packagings or shrinkage of the resulting composite film are avoided, which may otherwise occur when an excessive amount of material of the layer (a) is used. In addition, the provision of a thin outermost layer (a) ensures a high degree of smoothness or suppleness of the resulting composite film.

It is further provided that none of the layers of the composite film which are disposed between the layer (a) and the layer (c) contains a polyamide (PA).

This restriction results in greater dimensional stability combined with lower stiffness. In addition, a lower cold shrinkage is achieved.

Furthermore, it is envisaged that none of the layers of the composite film which are disposed between the layer (a) and the layer (c) contains an ethylene-vinyl alcohol copolymer (EVOH).

Advantageously, the composite film according to the invention can completely dispense with the use of an ethylene-vinyl alcohol copolymer (EVOH) as a layer component in the inner layers by providing PVdC in the layer (b). This prevents the decrease of the barrier function due to external moisture influence on the composite film, which occurs with EVOH as barrier material. In this way, a sufficient barrier function with long-term stability can be ensured despite or precisely because of the absence of EVOH.

According to the invention, an “inner layer” is understood to be a layer within the composite film according to the invention, which is disposed between the layer (a) and the layer (c).

Compared to the alternative case using EVOH in an inner layer, in which a correspondingly more complex layer structure with an increased total number of layers is required so that sandwich layers can be provided to protect the embedded EVOH layer, the additional “protective layers” can be dispensed with according to the invention. This simplifies the overall structure and manufacturing method of the composite film. In addition, the manufacturing costs are reduced.

Moreover, by omitting EVOH and PA in the inner layers as described above, a relatively stiff composite film can be avoided if these materials are used in larger percentages of the layer material. Furthermore, the disadvantage of these materials of causing post-crystallization of the composite film and thus impairing the dimensional stability can be avoided.

Furthermore, the composite film may have a (hot) shrinkage of at least 20%, preferably at least 25%, in particular at least 50%, in each of the longitudinal and transverse directions, measured in water at 90° C., preferably within 1 second after immersion, but at least within 10 seconds after immersion.

Additionally or alternatively, the composite film may have a total area shrinkage (total shrinkage referring to the area) of at least 40%, preferably at least 50%, more preferably at least 100%, measured in water at 90° C., preferably within 1 second after immersion, but at least within 10 seconds after immersion.

According to the invention, in order to determine the hot shrinkage the sample or specimen is immersed in water at 90° C. for a predetermined period of time, in particular for the aforementioned period of time, and, after removal, is immediately cooled with water to room temperature. The length of a pre-marked section after this treatment is measured and based on the measured length of the same section of the sample before treatment. The resulting length ratio (“shrunk” to “not shrunk”), given in percent, defines the shrinkage. Depending on the direction of the length measurement, the shrinkage results in the longitudinal (MD) and in the transverse direction (TD). The total shrinkage is calculated by adding the shrinkage in the longitudinal and transverse directions. Multiple determinations, such as triple or quintuple determinations, of the length measurements, and the formation of the corresponding average values therefrom, advantageously increase the accuracy of the determination. According to the invention, the shrinkage and the total shrinkage can be determined in particular according to ASTM 2732.

By means of the method according to the invention, composite films can be advantageously manufactured which consequently have a high shrinkage in both the longitudinal direction (longitudinal/machine direction) and the transverse direction (cross direction). This means that even the high claims made on the resulting composite film, such as those made on a shrink film for packaging a food product such as meat, fish or cheese, are fulfilled.

According to the invention, the composite film may further comprise the following layered structure, counting from the outside to the inside, comprising at least seven layers, wherein:
a first layer from the outside contains or consists of a polyethylene terephthalate (PET), a polyamide (PA), a polylactic acid (PLA), or any mixture thereof, as a layer component;
a second layer from the outside contains or consists of a adhesion promotor (HV) as a layer component;
a third layer from the outside contains or consists of a polyolefin (PO), preferably a polypropylene (PP) or a polyethylene (PE), an ethylene-vinyl acetate copolymer (EVA), an ionomer (TO), an ethylene-methyl methacrylate copolymer (EMMA), an ethylene-methacrylic acid copolymer (EMA), or any mixture thereof, as a layer component;
a fourth layer from the outside contains or consists of an adhesion promoter (HV) as a layer component;
a fifth layer from the outside contains or consists of a polyvinylidene chloride (PVdC) as a layer component;
a sixth layer from the outside contains or consists of an adhesion promoter (HV) as a layer component; and
a seventh layer from the outside contains or consists of a polyolefin (PO), preferably a polyethylene (PE) or a polypropylene (PP), an ethylene-vinyl acetate copolymer (EVA), an ionomer (TO), an ethylene-methyl methacrylate copolymer (EMMA), an ethylene-methacrylic acid copolymer (EMA), or any mixture thereof, as a layer component.

In addition to the above-mentioned advantages of this specific composite structure, the composite film has a high heat resistance. In addition, the composite film is not too stiff.

In addition to the above-described method according to the invention, its direct product is also claimed in claim 10, which solves the object. Here, the advantages of the method discussed above apply analogously.

Furthermore, the object according to the invention is solved in terms of the product by the composite film according to claim 11. The advantages and modifications of the method according to the invention discussed above also apply analogously to the composite film according to the invention.

Thus, a multilayered composite film is claimed, which is preferably manufactured and biaxially oriented or oriented by means of the jet-blow method or jet blow molding method or nozzle blow molding method, and in particular is manufactured by the method according to any one of claims 1 to 9. The composite film includes at least three layers (a), (b) and (c), of which
the layer (a) forms an outward surface of the composite film;
the layer (c) forms a surface of the composite film facing or coming in contact with a good to be packaged; and
the layer (b) is disposed between the layer (a) and the layer (c);

Here, the layer (a) contains or consists of a thermoplastic resin. The layer (b) contains or consists of a polyvinylidene chloride (PVdC) resin. Further, the layer (c) contains or consists of a resin, preferably a sealable, especially heat-sealable resin. The thermoplastic resin of the layer (a) has a density of 0.94 g/cm³ or more. Therein, any crosslinking of the composite film by means of radioactive radiation, in particular by means of beta, gamma, X-ray and/or electron irradiation, is omitted during the manufacturing of the composite film and/or thereafter.

Advantageous embodiments are the subject-matter of the dependent claims. Thus, the features discussed for the above method according to the invention may also be used for advantageously limiting the composite film according to the invention, as recited in claims 12 to 19.

Finally, the use of a composite film according to any one of claims 10 to 19 or of a casing made therefrom for packaging an item, preferably a food or luxury food product, in particular a food product containing meat, fish or cheese, is claimed.

With the use of the composite film according to claim 20, the advantages of the composite film according to the invention can be ideally utilized, particularly in the packaging of goods sensitive to light, oxygen, temperature and/or aroma, such as in particular food. The composite film according to the invention provides ideal protection for sensitive goods to be packaged, in addition to the advantages described above.

### EMBODIMENTS

TABLE 10
Layered structures of exemplary composite films according to the
invention with seven layers, not radiation crosslinked: layer
components and layer thicknesses (total thickness 50 μm each)

| | Layer 1 | | | | | | Layer 7 |
|---|---|---|---|---|---|---|---|
| Example | (outside) | Layer 2 | Layer 3 | Layer 4 | Layer 5 | Layer 6 | (inside) |
| 1 | PET | HV | PP | HV | PVDC | HV | PE |
| | 5 μm | 2.5 μm | 20 μm | 2.5 μm | 5 μm | 2.5 μm | 12.5 μm |
| 2 | PET | HV | IO | HV | PVDC | HV | EVA |
| | 2.5 μm | 2.5 μm | 20 μm | 2.5 μm | 5 μm | 2.5 μm | 15 μm |
| 3 | PA | HV | EVA | HV | PVDC | HV | EVA |
| | 5 μm | 2.5 μm | 17.5 μm | 2.5 μm | 5 μm | 2.5 μm | 15 μm |

However, the invention is not limited to the embodiments mentioned, in particular not to the total thickness of the layer structure and the thickness ratios of the individual layers as indicated in Table 10. Thus, the invention also expressly includes the layer sequences of Examples 1 to 3 of Table 10, but with different layer thicknesses than those indicated in Table 10 and different overall thicknesses in each case.

### Further Disclosure and Alternatives

The method according to the invention and the composite film according to the invention can preferably be carried out or manufactured using the so-called double-bubble and in particular the triple-bubble method, for which the applicant provides suitable equipment, which are known to the skilled person. Therein, the multilayered composite film can be co-extruded from the respective resin melts, for example, by means of a nozzle blow head of the applicant, set up for manufacturing composite films with three or more layers, preferably with thermal separation of the individual layers, cooled with a water cooling system of the applicant, reheated, biaxially oriented by means of an enclosed compressed air bubble and finally thermoset or thermofixed in a further step in a defined temperature regime. The composite film according to the present invention can be a composite film comprising a barrier against gas diffusion, in particular oxygen diffusion, and/or against water vapor diffusion.

The composite film of the present invention can be advantageously obtained on a device or system of the same applicant for manufacturing tubular food films for food packaging, such as, for example, shrink films or shrink bags, by the jet-blow method or jet blow molding method or nozzle blow molding method, if the device disclosed in patent specification DE 199 16 428 B4 of the same applicant for rapidly cooling thin thermoplastic tubes after their extrusion is additionally used. For this purpose, a corresponding further development according to patent specification DE 100 48 178 B4 can also be taken into account.

Therein, the tubular film produced from the plastic melt in the nozzle blow head is subjected to intensive cooling, during which the amorphous structure of the thermoplastic from the plastic melt is retained. The tubular film extruded vertically from the plastic melt in the nozzle blow head initially moves without wall contact into the cooling device for cooling, as described in detail in the patent documents or publications DE 199 16 428 B4 and DE 100 48 178 B4. In order to avoid repetition, full reference is made to the contents of DE 199 16 428 B4 and DE 100 48 178 B4 with regard to details of the methods, structure and mode of operation of this cooling system, which is also referred to as a calibration system.

The tubular film then passes through supports in the cooling system, against which the film is supported as a result of a differential pressure between the interior of the tubular film and the coolant, wherein a liquid film is maintained between the film and the supports, so that sticking of the tubular film is excluded. The diameter of the supports influences the diameter of the tubular film, which is why this cooling system of the same applicant is also referred to as a calibration system.

According to the invention, polyvinylidene chloride (PVdC) is a thermoplastic formed from vinylidene dichloride (1,1-dichloroethene) analogous to PVC. PVdC decomposes near the melting point of about 200° C.

According to the invention, polyamide (PA) may be a substance selected from a group consisting of PA of ϵ-caprolactam or poly(c-caprolactam) (PA6), PA of hexame-thylenediamine and adipic acid or polyhexamethyleneadipinamide (PA6.6), PA of ϵ-ca-prolactam and hexamethylenediamine/adipic acid (PA6.66), PA of hexamethylenediamine and dodecanedioic acid or polyhexamethylenedodecanamide (PA6.12), PA of 11-aminoundecanoic acid or polyundecanamide (PA11), PA of 12-laurinlactam or poly(w-laurinlactam) (PA12), or a mixture of these PAs or a mixture of these PAs with amorphous PA or with other polymers. The generic notation PAx.y is synonymous with PAx/y or PAxy.

For the purpose of this application, polyolefin (PO) may be a substance selected from a group consisting of PP, PE, LDPE, LLDPE, polyolefin plastomer (POP), ethylene-vinyl acetate copolymers (EVA), ethylene-methyl methacrylate copolymers (EMMA), ethylene-methacrylic acid copolymers (EMA), ethylene-acrylic acid copolymers (EAA), copolymers of cycloolefins/cycloalkenes and 1-alkenes or cycloolefin copolymers (COC), ionomers (IO), or a mixture or blend thereof. Furthermore, PO can be a mixture of the above PO with ionomers.

In the context of the present invention, polyester can be used as a layer component for the layer (a). Polyesters are polymers with ester functions in their main chain and can in particular be aliphatic or aromatic polyesters. Polyesters can be obtained by polycondensation of corresponding dicarboxylic acids with diols. Any dicarboxylic acid suitable for forming a polyester can be used to synthesize the polyester, in particular terephthalic acid and isophthalic acid, as well as dimers of unsaturated aliphatic acids. As the further component for the synthesis of the polyester, diols can be used, such as:

polyalkylene glycols, such as ethylene glycol, propylene glycol, tetramethylene glycol, neopentyl glycol, hexamethylene glycol, diethylene glycol, polyethylene glycol and polytetramethylene oxide glycol; 1,4-cyclohexanedimethanol, and 2-alkyl-1,3-propanediol.

PET, which stands for the polyester polyethylene terephthalate, is particularly preferred. PET can be obtained by polycondensation of terephthalic acid (1,4-benzenedicarboxylic acid) and ethylene glycol (1,2-dihydroxyethane).

Another preferred polyester is the polylactides or polylactic acids (PLA), which can be included as layer components in the layers for which a polyester is provided as a layer component. These polymers are biocompatible/biodegradable and have high melting temperatures or high melting points and a good tensile strength in addition to a low moisture absorption.

In the context of the present invention, EVOH stands for EVOH as well as for a blend of EVOH with other polymers, ionomers, EMA or EMMA. In particular, EVOH also includes a blend of EVOH and PA or of EVOH and ionomer.

The adhesion promotors (HV) stand for adhesive layers that ensure good adhesion of the individual layers to each other. HV can be based on a base material selected from a group, consisting of PE, PP, EVA, EMA, EMMA, EAA and an ionomer, or a mixture thereof. Particularly suitable adhesion promotors (HV) according to the invention are EVA, EMA or EMMA, each with a purity of >99%, preferably >99.9%.

According to a further preferred embodiment, layers comprising HV as a layer component may also comprise a mixture of PO and HV or a mixture of EVA, EMA, EMMA and/or EAA and HV or a mixture of ionomer and HV or a mixture of a plurality of HV.

For the purposes of the present invention, a processability (number of cycles) means the speed (units per unit time) at which the composite film produced according to the invention can be further processed into usable packaging units, such as shrink bags for food products. This can include, for example, the formation of a bag shape, the application of sealing seams and, in a broader sense, possibly also the filling with the good to be packaged and the sealing of the filled package.

For the purposes of the present invention, the designation of a material as a “layer component” means that a layer of the food film according to the invention comprises this material at least in part. In this context, the designation “layer component” within the meaning of the present invention may in particular include that the layer consists entirely or exclusively of this material.

The composite film according to the invention is preferably sheet-like or tubular. Preferably, the composite film is a food product film or food product casing. The composite film is further preferably suitable for use as a heat-shrinkable packaging material.

In the context of this application, “crosslinked by radiation” or “radiation crosslinked” means crosslinking by means of radioactive radiation, preferably “crosslinking by means of beta, gamma, X-ray and/or electron radiation”. According to the invention, the omission of radiation crosslinking includes integrated and downstream radiation crosslinking during the manufacturing of the composite film.

1. Method for manufacturing a multilayered composite film, wherein the method includes at least the following steps:
a step of co-extruding at least three layers (a), (b) and (c) of which
the layer (a) forms an outward surface of the composite film;
the layer (c) forms a surface of the composite film facing or coming in contact with a good to be packaged; and
the layer (b) is disposed between the layer (a) and the layer (c); and
a step of biaxial orientation of the composite film thus co-extruded;
wherein the layer (a) contains or consists of a thermoplastic resin;
wherein the layer (b) contains or consists of a polyvinylidene chloride (PVdC) resin;
wherein the layer (c) contains or consists of a resin, preferably a sealable resin, in particular a heat-sealable resin;
wherein the thermoplastic resin of the layer (a) has a density of 0.94 g/cm³ or more; and
wherein any crosslinking of the composite film by means of radioactive radiation, in particular by means of beta, gamma, X-ray and/or electron irradiation, is omitted during the manufacturing of the composite film and/or thereafter.

2. Method according to claim 1, wherein the thermoplastic resin of the layer (a) contains or consists of a polyester, preferably a polyethylene terephthalate (PET), or a polylactic acid or a polylactide (PLA), a polyamide (PA), a polyolefin (PO), an ethylene-vinyl acetate copolymer (EVA), an ethylene-methyl methacrylate copolymer (EMMA), an ethylene-methacrylic acid copolymer (EMA), an ionomer (IO), or any mixture thereof; and/or the thermoplastic resin of the layer (a) has a sealing temperature which is equal to or higher than the sealing temperature of the resin of the layer (c); and/or
the thermoplastic resin of the layer (a) has a melting temperature of 170° C. or higher, preferably 175° C. or higher, preferably 180° C. or higher.

3. Method according to claim 1, wherein
the resin of the layer (c) contains or consists of a polyolefin (PO), preferably a polyethylene (PE) and/or a polypropylene (PP), an ethylene-vinyl acetate copolymer (EVA), an ionomer (10), an ethylene-methyl methacrylate copolymer (EMMA), an ethylene-methacrylic acid copolymer (EMA), or any mixture thereof.

4. Method according to claim 1, wherein
the layer (a) has a thickness in the range of 0.5 to 20 μm, preferably 1 to 10 μm; and/or
the thickness of the layer (a) is at most 30%, preferably at most 10%, in particular at most 5%, of the thickness of the entire composite film.

5. Method according to claim 1, wherein
none of the layers of the composite film which are disposed between the layer (a) and the layer (c) contains a polyamide (PA).

6. Method according to claim 1, wherein
none of the layers of the composite film which are disposed between the layer (a) and the layer (c) contains an ethylene-vinyl alcohol copolymer (EVOH).

7. Method according to claim 1, wherein
the composite film has a shrinkage of at least 20%, preferably at least 25%, in particular at least 50%, in each of the longitudinal and transverse directions, measured in water at 90° C., preferably within 1 second after immersion, but at least within 10 seconds after immersion; an/or
the composite film has a total area shrinkage of at least 40%, preferably at least 50%, more preferably at least 100%, measured in water at 90° C., preferably within 1 second after immersion, but at least within 10 seconds after immersion.

8. Method according to claim 1, wherein
the composite film further comprises the following layered structure, counting from the outside to the inside, comprising at least seven layers, wherein:
a first layer from the outside contains or consists of a polyethylene terephthalate (PET), a polyamide (PA), a polylactic acid (PLA), or any mixture thereof, as a layer component;
a second layer from the outside contains or consists of a adhesion promotor (HV) as a layer component;
a third layer from the outside contains or consists of a polyolefin (PO), preferably a polypropylene (PP) or a polyethylene (PE), an ethylene-vinyl acetate copolymer (EVA), an ionomer (10), an ethylene-methyl methacrylate copolymer (EMMA), an ethylene-methacrylic acid copolymer (EMA), or any mixture thereof, as a layer component;
a fourth layer from the outside contains or consists of an adhesion promoter (HV) as a layer component;
a fifth layer from the outside contains or consists of a polyvinylidene chloride (PVdC) as a layer component;
a sixth layer from the outside contains or consists of a adhesion promoter (HV) as a layer component; and
a seventh layer from the outside contains or consists of a polyolefin (PO), preferably a polyethylene (PE) or a polypropylene (PP), an ethylene-vinyl acetate copolymer (EVA), an ionomer (10), an ethylene-methyl methacrylate copolymer (EMMA), an ethylene-methacrylic acid copolymer (EMA), or any mixture thereof, as a layer component.

9. Method according to claim 1, wherein
the composite film has a haze of at most 15%, preferably at most 12%, preferably at most 10%, preferably at most 7%, in particular at most 5%; and/or
the composite film has a stiffness, expressed as modulus of elasticity, measured in the machine direction, of at least 200 MPa, preferably at least 250 MPa, preferably at least 300 MPa, preferably at least 350 MPa, preferably at least 400 MPa, in particular at least 450 MPa; and/or
the composite film has a stiffness, expressed as modulus of elasticity, measured in the transverse direction, of at least 200 MPa, preferably at least 250 MPa, preferably at least 300 MPa, preferably at least 350 MPa, preferably at least 400 MPa, in particular at least 450 MPa; and/or
the composite film has a stiffness, expressed as modulus of elasticity, measured in the machine direction, of at most 700 MPa, preferably at most 650 MPa, preferably at most 600 MPa, preferably at most 550 MPa, in particular at most 500 MPa, and/or
the composite film has a stiffness, expressed as modulus of elasticity, measured in the transverse direction, of at most 700 MPa, preferably at most 650 MPa, preferably at most 600 MPa, preferably at most 550 MPa, in particular at most 500 MPa.

10. A multilayered composite film manufactured by the method claim 1.

11. Multilayered composite film, preferably manufactured by means of the jet-blow method or jet blow molding method or nozzle blow molding method and biaxially oriented, in particular manufactured by the method according to claim 1;
wherein the composite film includes at least three layers (a), (b) and (c), of which
the layer (a) forms an outward surface of the composite film;
the layer (c) forms a surface of the composite film facing or coming in contact with a good to be packaged; and
the layer (b) is disposed between the layer (a) and the layer (c);
wherein the layer (a) contains or consists of a thermoplastic resin; wherein the layer (b) contains or consists of a polyvinylidene chloride (PVdC) resin,
wherein the layer (c) contains or consists of a resin, preferably a sealable, especially heat-sealable resin;
wherein the thermoplastic resin of the layer (a) has a density of 0.94 g/cm³ or more; and
wherein any crosslinking of the composite film by means of radioactive radiation, in particular by means of beta, gamma, X-ray and/or electron irradiation, is omitted during the manufacturing of the composite film and thereafter.

12. Composite film according to claim 11, wherein
the thermoplastic resin of the layer (a) contains or consists of a polyester, preferably a polyethylene terephthalate (PET) or a polylactic acid or a polylactide (PLA), a polyamide (PA), a polyolefin (PO), an ethylene-vinyl acetate copolymer (EVA), an ethylene-methyl methacrylate copolymer (EMMA), an ethylene-methacrylic acid copolymer (EMA), an ionomer (IO), or any mixture thereof; and/or the thermoplastic resin of the layer (a) has a sealing temperature which is equal to or higher than the sealing temperature of the resin of the layer (c); and/or the thermoplastic resin of the layer (a) has a melting temperature of 170° C. or higher, preferably 175° C. or higher, preferably 180° C. or higher.

13. Composite film according to claim 11, wherein
the resin of the layer (c) contains or consists of a polyolefin (PO), preferably a polyethylene (PE) and/or a polypropylene (PP), an ethylene-vinyl acetate copolymer (EVA), an ionomer (10), an ethylene-methyl methacrylate copolymer (EMMA), an ethylene-methacrylic acid copolymer (EMA), or any mixture thereof.

14. Composite film according to claim 11, wherein
the layer (a) has a thickness in the range of 0.5 to 20 μm, preferably 1 to 10 μm; and/or
the thickness of the layer (a) is at most 30%, preferably at most 10%, in particular at most 5%, of the thickness of the entire composite film.

15. Composite film according to claim 11, wherein
none of the layers of the composite film which are disposed between the layer (a) and the layer (c) contains a polyamide (PA).

16. Composite film according to claim 11, wherein
none of the layers of the composite film which are disposed between the layer (a) and the layer (c) contains an ethylene-vinyl alcohol copolymer (EVOH).

17. Composite film according to claim 11, wherein
the composite film has a shrinkage of at least 20%, preferably at least 25%, in particular at least 50%, in each of the longitudinal and transverse directions, measured in water at 90° C., preferably within 1 second after immersion, but at least within 10 seconds after immersion; an/or
the composite film has a total area shrinkage of at least 40%, preferably at least 50%, more preferably at least 100%, measured in water at 90° C., preferably within 1 second after immersion, but at least within 10 seconds after immersion.

18. Composite film according to claim 11, wherein
the composite film further comprises the following layered structure, counting from the outside to the inside, comprising at least seven layers, wherein:
a first layer from the outside contains or consists of a polyethylene terephthalate (PET), a polyamide (PA), a polylactic acid (PLA), or any mixture thereof, as a layer component;
a second layer from the outside contains or consists of a adhesion promotor (HV) as a layer component;
a third layer from the outside contains or consists of a polyolefin (PO), preferably a polypropylene (PP) or a polyethylene (PE), an ethylene-vinyl acetate copolymer (EVA), an ionomer (10), an ethylene-methyl methacrylate copolymer (EMMA), an ethylene-methacrylic acid copolymer (EMA), or any mixture thereof, as a layer component;
a fourth layer from the outside contains or consists of an adhesion promoter (HV) as a layer component;
a fifth layer from the outside contains or consists of a polyvinylidene chloride (PVdC) as a layer component;
a sixth layer from the outside contains or consists of a adhesion promotor (HV) as a layer component; and
a seventh layer from the outside contains or consists of a polyolefin (PO), preferably a polyethylene (PE) or a polypropylene (PP), an ethylene-vinyl acetate copolymer (EVA), an ionomer (10), an ethylene-methyl methacrylate copolymer (EMMA), an ethylene-methacrylic acid copolymer (EMA), or any mixture thereof, as a layer component.

19. Composite film according to claim 11, wherein
the composite film has a haze of at most 10%, preferably at most 5%; and/or
the composite film has a stiffness, expressed as modulus of elasticity, measured in the machine direction, of at least 200 MPa, preferably at least 250 MPa, preferably at least 300 MPa, preferably at least 350 MPa, preferably at least 400 MPa, in particular at least 450 MPa; and/or
the composite film has a stiffness, expressed as modulus of elasticity, measured in the transverse direction, of at least 200 MPa, preferably at least 250 MPa, preferably at least 300 MPa, preferably at least 350 MPa, preferably at least 400 MPa, in particular at least 450 MPa; and/or
the composite film has a stiffness, expressed as modulus of elasticity, measured in the machine direction, of at most 700 MPa, preferably at most 650 MPa, preferably at most 600 MPa, preferably at most 550 MPa, in particular at most 500 MPa, and/or
the composite film has a stiffness, expressed as modulus of elasticity measured in the transverse direction, of at most 700 MPa, preferably at most 650 MPa, preferably at most 600 MPa, preferably at most 550 MPa, in particular at most 500 MPa.

20. Use of a composite film according to claim 10 or of a casing made therefrom for packaging an item, preferably a food or luxury food product, in particular a food product containing meat, fish or cheese.
